(19) United States
(12) Patent Application Publication
(10) Pub. No.: US 2022/0212442 A1
(43) Pub. Date: Jul. 7, 2022

(54) POLYMERIC MATRIX PLYWOOD

(71) Applicant: Amin Bakhshandeh, Karaj (IR)

(72) Inventor: Amin Bakhshandeh, Karaj (IR)

(21) Appl. No.: 17/611,227

(22) PCT Filed: Jul. 15, 2020
(86) PCT No.: PCT/IR2020/050021

§ 371 Date: Dec. 1, 2021

(30) Foreign Application Priority Data
May 16, 2019 (IR) 13985014000300144

(51) Int. Cl. B32B 5/30; B32B 5/02; B32B 21/14; B32B 21/02; B27N 3/00; B27N 3/02

(52) U.S. Cl. CPC B32B 5/30; B32B 5/024; B32B 21/14; B32B 21/02; B27N 3/08; B27N 3/02; B32B 2264/067; B32B 2260/021; B32B 2260/046; B27N 3/002

(57) ABSTRACT

Polymeric Matrix Plywood (PMP) is the technical knowledge of manufacturing and using polyolefin resin(One part), for making primers, adhesives and paints, with a process at room temperature And applied in wood and plastic industries and pre-processing of thin wood veneers and plywood construction with Making it possible to glue wooden and plastic layers together and effective penetration of primer and polyolefin adhesive to both wood and thermoplastics materials surfaces, With high penetration and saturation of wood textures and vessels, for making recyclable and renewable polyolefin adhesives and paints for wood, with the possibility of adding electrical conductivity to polyolefin resin And obtaining anti-electrostatic properties of the resulting surfaces, and creating the necessary conditions for plating wooden or plastic surfaces, [FIG. 2].

### TECHNICAL FIELD

B27D; B27D 1/04; B27G 11/00; B32B 27/32; H01 R 4/04.

### BACKGROUND ART

In 1797 Samuel Bentham applied for patents covering several machines to produce veneers. In his patent applications, he described the concept of laminating several layers of veneer with glue to form a thicker piece—the first description of what we now call plywood.[1], about fifty years later Immanuel Nobel, father of Alfred Nobel, realized that several thinner layers of wood bonded together would be stronger than a single thick layer of wood. Understanding the industrial potential of laminated wood, he invented the rotary lathe.[2], In 1928, the first standard-sized 4 ft by 8 ft (1.2 m by 2.4 m) plywood sheets were introduced in the United States for use as a general building material.[1].

### SUMMARY OF INVENTION

Polymeric Matrix Plywood is the technical knowledge of making plywood from a combination of wood and plastic, in which polyolefin resin and applied cross joints play an essential role, in combining and reinforcing these materials with each other in making a layered composite.

### TECHNICAL PROBLEM

This traditional plywood production method has been the only economical and commercial method of plywood production to date, over the past 223 years And even in 1907, when Leo Baekeland made the first synthetic plastic, he compressed the phenol with formaldehyde, made formaldehyde or Bakelite phenolic adhesive, which is also resistant to moisture, and replaced it with urea formaldehyde adhesive and or in recent decades, with the introduction and combination of adhesives, resins, and thermoplastic and thermostatic polymeric materials that activated by pressure and heat, or with the use of catalysts, Such as polyolefin and thermoplastic waste films in patents US: 20140272403 and or copolyester adhesive compounds such as USP: 20020142145 & U.S. Pat Nos. 5,423,933& 5,698,061 or use polyolefin films such as USP: 20110091683 or by the process of self-polymerization of Two-part and thermoset, A combination of Isocyanate and kaolin adhesives used in KR: 20180033236A or a combination of polyester resin and thermal thermoplastic film and thin wood veneers such as U.S. Pat No. 5,194,310 , however, in the process of making plywood and processing thin wood veneers, the following basic challenges have prevented the commercial and practical presence of these inventions in the global consumer market, instead of the traditional and cheap 200-year-old and common method of composition, Toxic formaldehyde

[symbol]

1—Increasing the energy consumption and cost of the product, in order to increase the temperature and pressure of the process of activated adhesives with the mentioned pressure and heat to the melting point temperature of thermoplastic glass used in it, between (140 to 260) degrees Celsius and increase the pressure from (0. 8 to 10) Mega Pascal. 2—Executive limitations of rising heat: Limitations of the thickness of the plastic alloy film, which preferably has a thickness in the range (0.1 to 3 mm), such as patent: (CN201065614) which, if the PVC panel is 16 mm in diameter, between the layers of Plywood and be Temperatures above the PVC melting point and a pressure of 2 Mega Pascal, as a result, the PVC panel melts and cannot play the role of a thick filler between the layers. 3—Lack of chemical or physical adhesion of heat-resistant adhesives to pure thermoplastic materials: Such as the weakness of Isocyanate adhesive in adhesion to plastics, such as patent: (KR20180033236A) in which case the laminate or thin coating or wood board cannot be glued to the surface of thermoplastic sheets by this thermoset glue, To eliminate this defect in the U.S. Pat No.:7,575,813B2, 75% calcium carbonate is added to the thermoplastic material so that between the resulting thermoplastic layer to a diameter of 2 mm, it can penetrate a little epoxy adhesive to its surface and connect the veneer to the thermoplastic panel, However, in addition to not being completely waterproof and requiring the use of heat and high polymerization time, this technology has not been able to produce industrial and thick commercial boards from a combination of wood and plastic, This is because when high bending pressure is applied, the epoxy adhesive has a poor bond to the plastic, and 75% of the calcium carbonate used in the plastic makes it dry and brittle, and the problem of limiting the thickness of the thermoplastics still remains. 4—Products are not completely waterproof: Due to the high viscosity of thermal and molten adhesive or thermoset resin used in the manufacture of plywood and their inability to penetrate effectively into wooden vessels and tissues like water that penetrates into tissue and wood vessels), As a result, the woody and thirst part of the plywood and wood plastic composite becomes vulnerable to water penetration, Like cheap plywood made of wood for trees with wide and light leaves that do not have good resistance to water penetration. 5—Lack of use of wood-plastic, in products related to the interior due to the spread of bad plastic odor waste. 6—According the use of polyolefin resin in patent: (KR100842063 B1) to saturate the thin layer of wood and attach the thin layer of wood to plastic, this technology is still only suitable for making flooring with a thin coating of natural wood and so far from This method has not been used to make thick plywood with industrial application, Because the lack of cross-linking of the two-dimensional layers of the background matrix and composite fibers to each other, plus the high difference in hardness coefficient between them, It prevents the force from being transferred properly and creates excessive interfacial stress between the fiber network and the composite background matrix, Which causes the PVC foam to tear from the wood layer That this invention is without a solution and separating the correct processing method of polyolefin resin for wood impregnation from the processing method and using polyolefin resin to use it as just glue, It is not useful for making thick boards alone, And now there is no product in the global consumer market that combines wood and plastic without a diameter limit for wood or plastic, such as documentaries in [FIG. 8] & [FIG. 9], If the consumer market is thirsty for functional plywood made of a combination of wood and plastic, and providing solutions, especially in the greater participation of spongy and cheaper wood sheets, in the construction of waterproof plywood with industrial application, is an urgent needs This market. 7—Destructive penetration of thermosetting adhesive, through the pores between the tissue and the vessels of the wood veneer [FIG. 1-d], to the other surface of the veneer and filling the ends of the vessels on the other surface of the veneer, from a mixture of glue and flour [FIG. 5-a], If in standard mode, The vessels of the outer surface of the wood should be free of glue for painting [FIG. 5-b]. 8—In traditional plywood, the composite background matrix is layered and two-dimensional, and this is the most important reason for plywood Separation of layers against water penetration and flexural pressure [FIG. 3-c].

### SOLUTION TO PROBLEM

1—One-step conversion process of polyolefin glue, to a two-step process, for gluing wood layers to plastic in making plywood, Includes the first use of a thin solution of polyolefin primer (Formula. 1) and then the use of a thicker solution of polyolefin glue (Formula. 2), to deepen and make the penetration of polyolefin into the wood texture more effective and As a result, higher strength and adhesion of the adhesive layer and polyolefin paint to the wood layer, It is noteworthy that this primer and the type of solvent used such as Cyclohexanone play the most important role in converting natural wood texture into wood-plastic materials such as [FIG. 6], Also, the role that the solvent used in the primer with a volume of 90% can open in opening the three-dimensional entrance path of glue and paint to the wood-plastic pores, One of the most important microscopic factors is the greater strength of the two-stage connection. 2- To strengthen and create a scaffolding background matrix, it is possible to create regular holes on the surface of the wood fiber sheets, such as the [FIG. 1-e], by softening and gluing the surface of polyvinyl chloride sheets, with the adhesive and solvent cyclohexanone in it and press pressure And with the help of the press of the press machine, the softened layers of polyolefin with glue are injected into the pores of the mold as created by the wooden layer [FIG. 1-e] and in a regular and cross-sectional manner, the matrix of the substrate under and on the fiber layer is welded together [FIG. 2-e] & [FIG. 2-g] & [FIG. 8-d], Not only will this technology solve the problem of non-waterproofing of the traditional press adhesive method, but it will also be acceptable and standard, and will enclose layered composite fibers within the waterproof three-dimensional polymer background matrix but also, by creating a three-dimensional and soft load-bearing support for layered composite buildings [FIG. 8-d], When bending, with the help of better transmission of forces to eliminate the intensity of interlayer stress, It will make the plywood more practical and it is possible to use the layers of polyolefin thermoplastic sheets mentioned in the table: [FIG. 15-Table.1], in the construction of plywood and as one in the middle and without any limitation of the thickness of the sheet used between the wooden layers, provides good. 3—If it is necessary to make a plywood with a bending pressure and high hardness, it is possible to create regular holes in the surface unit and in a direction perpendicular to the surface of the plywood [FIG. 2-f] & [FIG. 8-f] and then by placing wooden transverse joints with a diameter of 8 mm in the created holes, the two-dimensional network turned the composite fibers into a three-dimensional matrix network, in order to better transfer the force in the three-dimensional network of the layered composite carrier, it will reduce the interlayer stress and increase the strength of the plywood against the layered phenomenon, on the other hand, with the interweaving of the two three-dimensional matrix of the background and the composite fibers, the connection between these two important composite items will be as strong as possible. 4—in the dry air process, the primer, glue, and paint (Formulas. 1, 2, & 3) are first vaporized the solvent resin, and then the polyvinyl chloride is transferred from the soft, liquid, and fluid phases to the relatively hard and solid phases, With the possibility of forming a thin polymer film, On the other hand, the solvent of this polyolefin resin can penetrate the dry wood vessels, lead the polyvinyl chloride molecular cloud strands soluble in cyclohexane hexane, with high capillary properties to the depth of the wood vessels, not only does it have a much higher degree of permeability than traditional solvent adhesives in water, it penetrates into the vessels and pores of the wood. Plant bitumen and excellent materials can be engineered and designed not only does it have a much higher degree of penetration into the vessels and wood pores than traditional water-soluble adhesives, but also whit uses a combination of excellent solvents such as chloroform in the adhesive composition, The ability to penetrate into pores and vessels filled with plant bitumen and excellent wood materials can be engineered and designed And he processed and saturated the wood, depending on the type (hard or soft and spongy). 5—In the final stage and to create a protective layer of the surface coating of the plywood or for patina and painting all wooden surfaces Can be provided from polyolefin resin solution (Formula. 3), suitable coating, to protect against weathering and detergents and acids, to cover wood surfaces and the traditional methods of painting wood with primer and natural or acrylic or thermostat oil paints, such as sealer, chlorine, semi-polyester, polishing oil and lacquer, obsolete and replaced With the possibility of continuous sanding and polishing and renewability [FIG. 8-e]. 6—In the expansion and replacement of thermostat adhesives for the construction of compact boards composed of mass particles of wood chips mixed with adhesive, such as chipboard and MDF, By replacing urea formaldehyde adhesive with primer solution and polyolefin adhesive (Formula. 1 & 2), with a two-step process, First, in the first step, by polyolefin primer solution (Formula. 1), by pre-processing and saturating the wood fiber chips, we turn the raw wood chips into a wood-plastic material, Then, after the primer dries and the wood-plastic fiber chips are mixed together And in the second step, in the following two ways, the resulting mass of wood-plastic particles can be converted into compressed wood-plastic. (a)—Mix the wood-plastic chips with a solution of polyolefin glue (Formula. 2), then the composite press at room temperature for half an hour and then complete the drying process in the open air for a day to a week depending on the diameter of the panel. (b)—Using a wood-plastic chip with a primer, but with a primer, with a higher concentration of polyolefin or more saturation steps, which causes more polyolefin to be absorbed into the wood texture and without the use of adhesive solution and directly and then the masses of wood-plastic particles are placed under a hot press, at a temperature higher than the melting temperature of the thermoplastic polyolefin glass used in the primer, Finally, the cooling operation is performed, in which the compressed board is ready for cutting after the cooling operation.

### ADVANTAGEOUS EFFECTS OF INVENTION

1—Expanding the construction of waterproofing boards, by adding design and engineering capability and changing the three physical items of the product, such as hardness, softness, density, with innovation, in the methods of making and pressing boards. (a)—Soft item: includes the scaffolding connection technique of plastic layers or composite background, which by changing the number and diameter of connections between layers, the softness of the composite can be changed, strengthened and engineered in a good range [FIG. 8-d] & [FIG. 2-e] & [FIG. 2-c]. (b)—It includes technologies that, when bent, to reduce the adverse effects of excessive traction and pressure between layers, as well as the softness of the polyolefin foam used, therefore, the separation of polyvinyl chloride foam from the wood layer is very effective and practical, and after The drilling operation is installed in the plywood, by pounding the wooden nails, in the holes created [FIG. 2-f] and [FIG. 8-f] It is also perpendicular to the surface tension vector between the polymer and wood layers, and by better transfer of force, in the composite load-bearing network and preventing excessive surface stress and tension between the interconnected layers of background (plastic) matrix and composite fibers (wood) and The transmission and distribution of these forces in the matrix network also increases the stiffness of the plywood against bending that By changing the number of these matrix connections per unit area of the plywood, it is possible to design, reinforce and engineering the hardness item and the tolerance threshold of the plywood, against bending forces on the surface, in a good range. (c)—Density Item: By placing the final product of the plywood under the pressure of hot press up to about (50-60) degrees Celsius, the polyvinyl chloride foam used is compressed to make the layers and as a result, the volume of the product is reduced, also by calculating and Design and pre-adjust the final proximity of the distance between the press plates, the density item can also be engineered. 2—One of the most important innovative aspects of the second-generation wood-plastic composite invention has been revealed, this is because the invention is the result of the combined properties of the following two traditional composites: a—Masses such as MDF, chipboard and wood-plastic (WPC) and b—Layers such as plywood, Because the base or matrix of the invention composite field is exposed, such as mass composites, with a matrix, it is three-dimensional, and the fibers or the main load-bearing network of the structural polymer board (PMP), such as traditional boards, are layered. 3—Making cold plywood: Technical knowledge of making polymeric matrix plywood,(PMP) has a process, at home temperature. 4—According to the revealed technical knowledge, after the completion of the manufacturing process and the drying of the adhesive and the evaporation and removal of the polymer solvent such as cyclohexanone, there will be no other toxic substances or volatile matter to be released from the composite layers, due to the fact that cyclohexanone in primers, adhesives, and paints (Formulas. 1, 2, 3) has been used in antibacterial and antifungal compounds as an active ingredient. 5—Innovation in the construction of second-generation wood-plastic boards, from a combination of wood and plastic layers [FIG. 9], without thickness restrictions for the use of any two-layer forming the main components of the background and composite fibers. 6—Making a layered composite, with the number of asymmetrical layers or even pairs, in one step of cold press. 7—Adhesion of the coating to the work board (wooden or plastic), by using a primer and polyolefin glue (Formulas. 1 and 2) at the right working time, with a reversible process that can be repaired and modified [FIG. 12]. 8—Inexpensive and high-quality processing of thin veneer or natural wood board: the penetration of polyolefin solution into the vessels and cellulose fibers of wood texture [FIG. 6-a, b] Raw wood becomes a material of wood-plastic composition [FIG. 6-c] as a result, the processed wood-plastic product is obtained, in addition to having mechanical and chemical properties of both wood and plastic materials It will be able to adhere well to plastics such as polyvinyl chloride and polyethylene at very low pressures and with the help of polyolefin glue (Formula. 2) and will be chemically welded. 9—Making pieces of plywood, flat and molded, in small workshops, by cold molds and without the need for high pressure to activate the glue. 10—Development of handicrafts, as a result of using primer and adhesive and paint that applied in wood and plastic industries [FIG. 11].

### BRIEF DESCRIPTION OF DRAWINGS

FIG. 1: (Polymeric matrix plywood press step)

[(a)=Polyvinyl chloride foam sheet with a cross section diameter (8 mm). (b)=Wood veneer with cross section diameter (1.5 mm). (c)=Punched wooden layer with a diameter of cross section (1.5 mm), with holes with a diameter (4 mm). (d)=Tissues forming the tissue of the natural role of the wood surface, with a length of about (1.5 mm). (e)=Holes created by a drill with a diameter of cross section (4 mm) and a hollow cylindrical chamber created, inside a plywood to a height (1.5 mm). (f)=Cold Press Pages.]

FIG. 2: (Polymeric matrix plywood product)

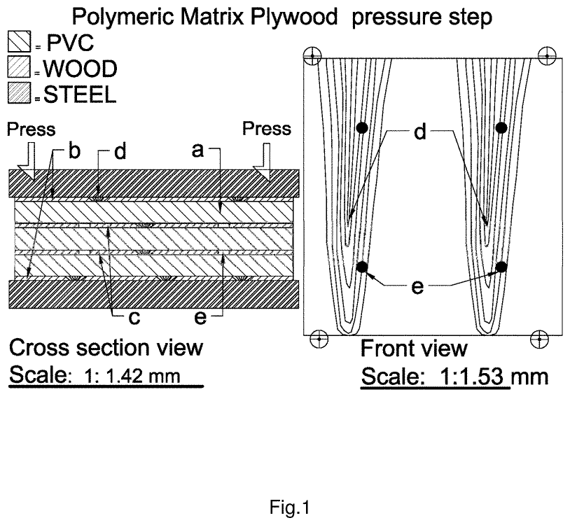

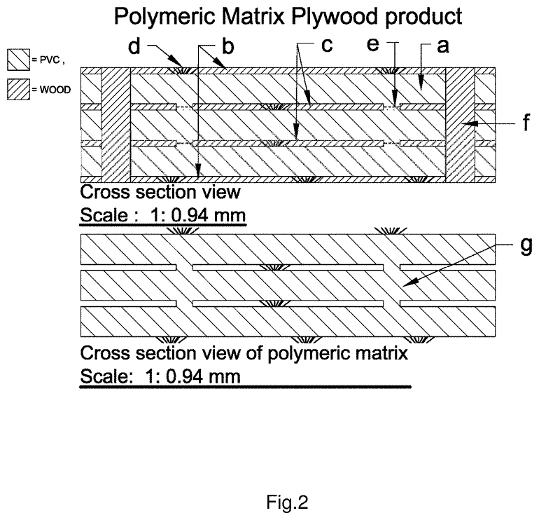

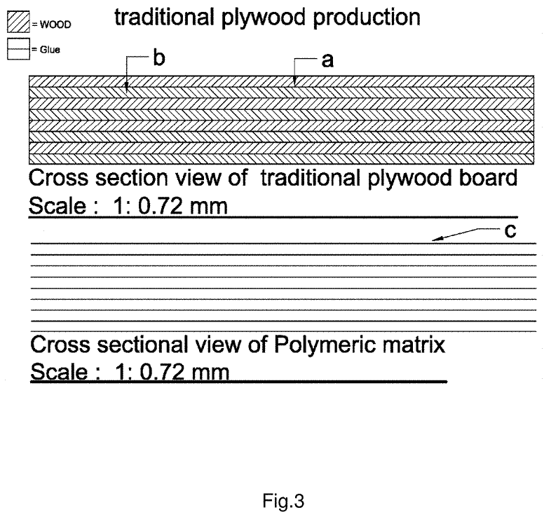

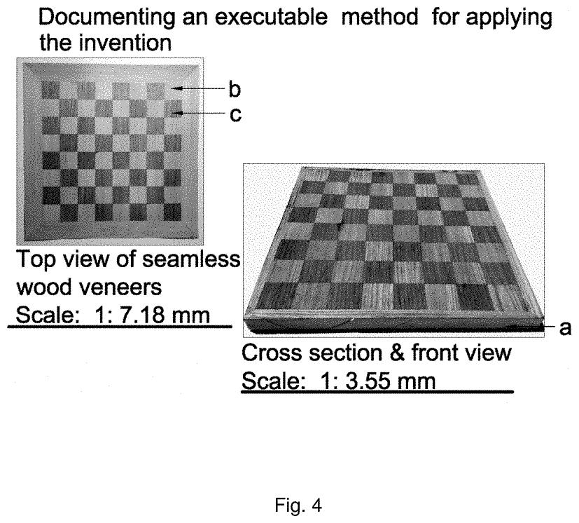

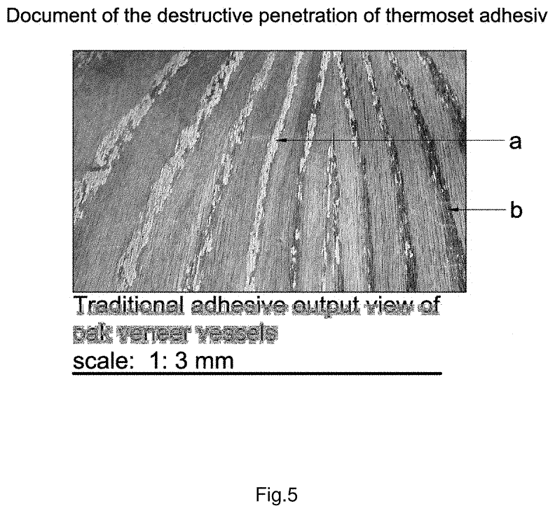

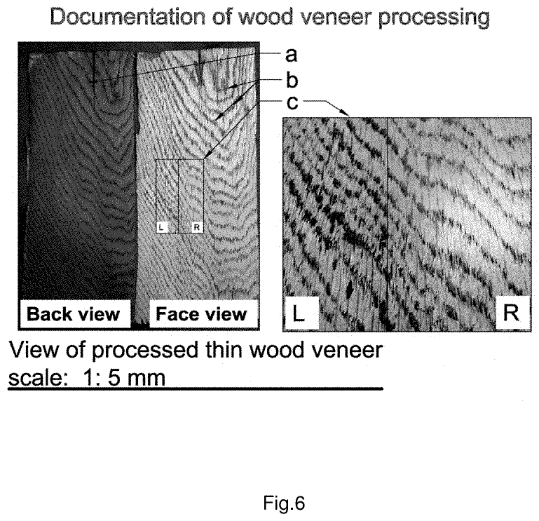

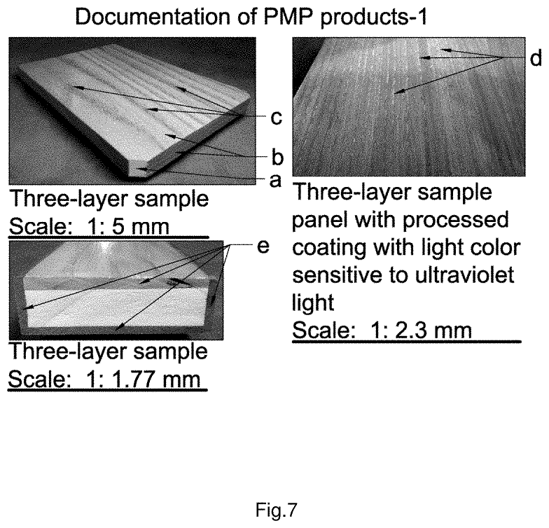

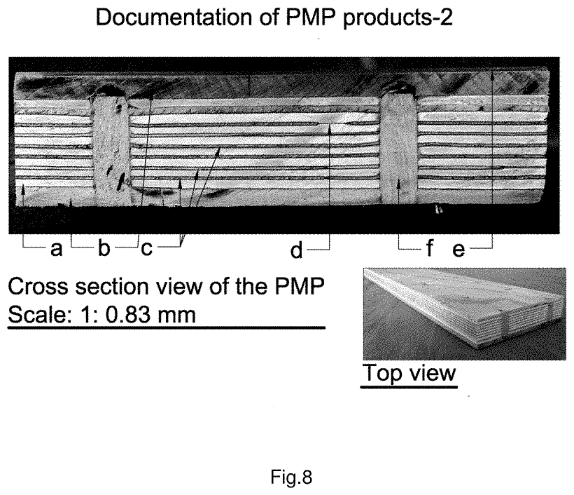

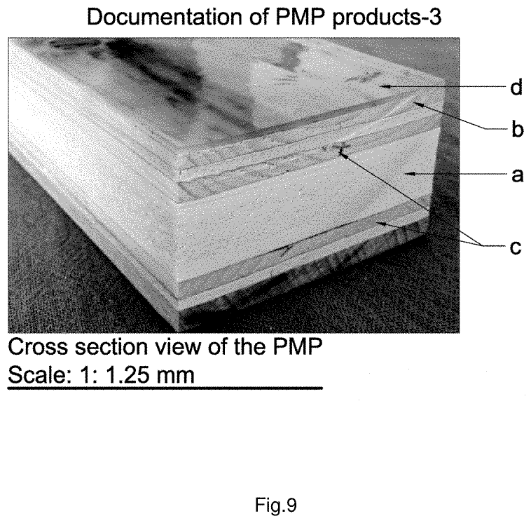

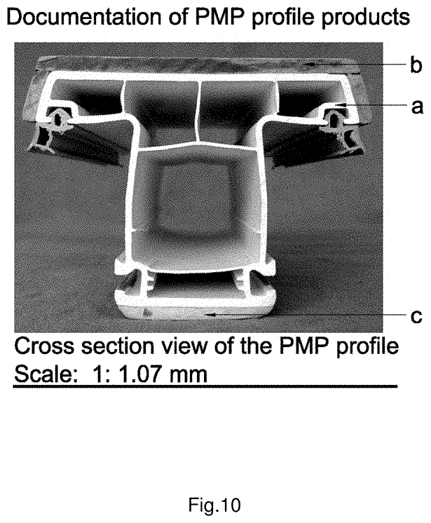

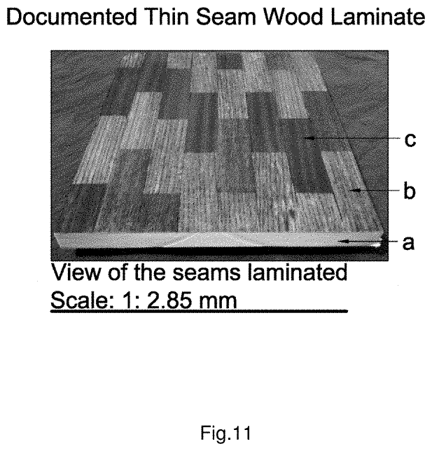

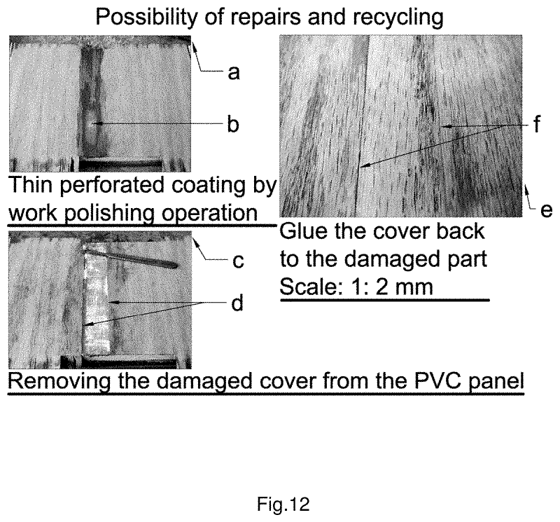

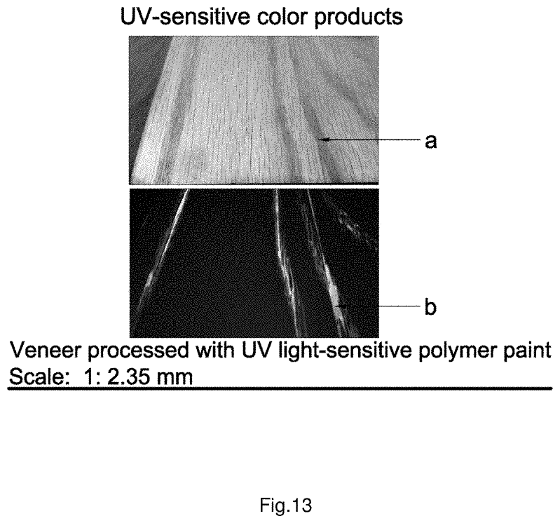

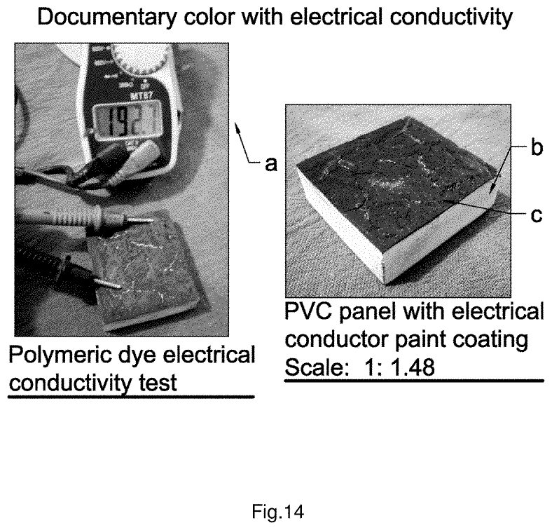

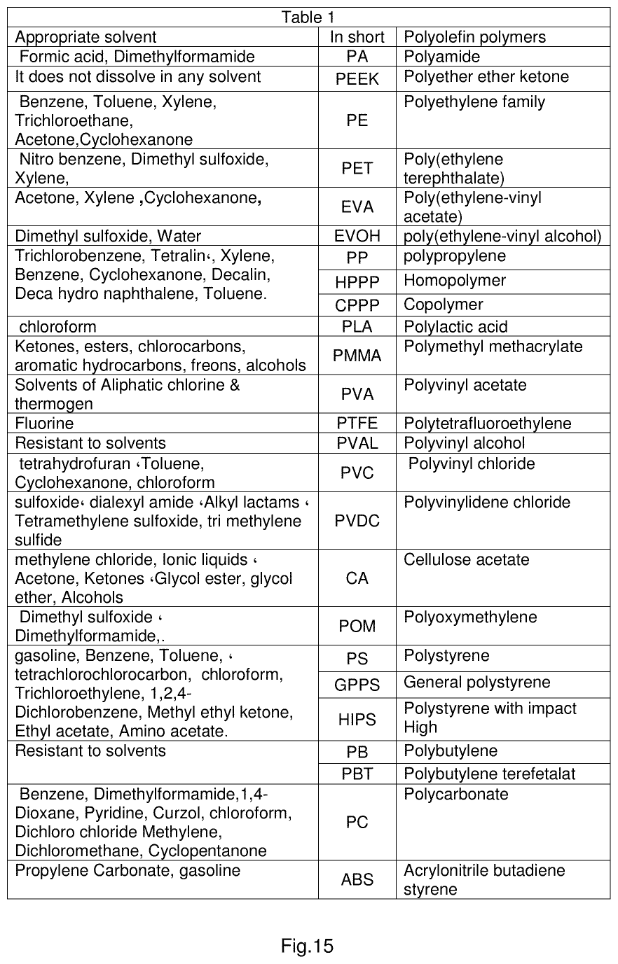

[(a)=Polyvinyl chloride in diameter (7.25 mm). (b)=Wood veneer with cross section diameter (1.5 mm). (c)=Wooden layer punched to a diameter (1.5 mm), with holes the diameter of the cross section (4 mm). (d)=Polyvinyl chloride connections created by saturation of vessels and pores forming the tissue of the knot and the natural engraving of the thin wood veneer. (6)=Matrix and pre-designed cylindrical connections, cross-sectional diameter (4 mm) and height (1.5 mm). (f)=Wooden nails with dimensions (8 mm in diameter and 27 mm in height) to strengthen the transmission of force in the composite fiber network and strengthen the hardness of the plywood. (g)=(Polymeric Matrix, PM), cross-sectional view of scaffolding structure of three-dimensional and polymeric matrix of composite background matrix and bearing layer support (with hypothetical removal of composite load-bearing fibers in the presented facade and before installing wooden transverse connections), to check the continuity of matrix background structure composite]

FIG. 3: (Sample plywood with traditional production method)

[(a)=A thin layer of urea formaldehyde adhesive, as a layered layer without interconnection between the layers and as a two-dimensional background matrix of traditional composite plywood, to a diameter of finally (0.2 mm), which in practice is less than this. (b)=wood board (2 mm in diameter). (c)=Cross-sectional view of adhesive polymer structure or traditional plywood composite background, in the form of thin two-dimensional layers with a diameter (0.2 mm) and discrete and unconnected (assuming the removal of wood fibers from the composite, in the presented view).]

FIG. 4: (Document an Executive Method for Using an Invention)

[(a)=Polyvinyl chloride foam sheet with dimensions: (165*255*255 mm). (b)=Ulmus glabra wood veneer, cut by laser device, with dimensions: (0.5*30*30 mm). (c)=Walnut wood veneer, cut by laser device, with dimensions: (0.5*30*30 mm).]

FIG. 5: (Document the penetration of thermo glue)

[(a)=White thermostatic adhesive (a combination of urea formaldehyde adhesive plus wheat flour) which, by pressing pressure, penetrates through the interstitial pores and vessels of natural wood veneer, to the other surface of the veneer, and penetrates the inside of the veneers. In order to change the color and make the texture more visible, the natural pattern of the wood has not been left. (b)=The sections of the wood-forming vessels in which the press adhesive has penetrated the least, and the outer and superficial ends of the vessel tubes are still empty and thirsty, and there is room for the patina paint to penetrate.]

FIG. 6: (Documentation of wood veneer processing)

[(a)=the back cover of the coating, which is impregnated with polyvinyl chloride solution in addition to the color pigment (Formula. 1). (b)=Polymer vinyl chloride facade, which has penetrated from the back surface of the veneer to the surface of the veneer, through the natural pattern of wood carvings, during processing by primer. (c)=Comparison view, between the raw coating treated with primer (left frame), with the same coating, after a short sanding and polishing by the fabric (right frame) that sanding the surface of the coating, the presence of polyvinyl chloride, in Among the saturated textures, oak wood, as a surface, plastic and glossy, appears after polishing operations.]

FIG. 7: (Documentation of PMP products-1)

[(a)=Polyvinyl chloride foam sheet with a diameter of (16 mm). (b)=Thin oak veneer treated with primer (Formula. 1), with a diameter (0.5 mm), for the back cover and on the foam of PVC sheet as well as the edge strip, for covering the cross-section of the cutting board. (c)=Polyvinyl chloride facade, which is penetrated by the primer solution, in addition to carbon powder and through the natural patterns of wood veneer, from the back surface of the veneer to the surface on the veneer. (d)=Three-ply board coated with a thin coating of beech wood, processed by ultraviolet light-sensitive lemon color, with a documentary view, under ultraviolet lamp light. (e)=Processed wood board with primer (Formula. 1) Walnut and spruce tongue, diameter (4 mm), for making wooden cans, with various uses and the ability to perform CNC milling operations on the surface of the boards, to create a prominent pattern.]

FIG. 8: (Documentation of PMP products-2)

[(a)=PVC sheet with a diameter (3 mm), which after compression and pressing operations, is compressed and converted to a diameter (1.5 mm), (b)=Ash wood board with a diameter of (4 mm) and beech wood board with a diameter (5 mm), as a surface and thick coating below and on the plywood. (c)=Six layers of red oak veneer treated with primer (Formula. 1), to (thickness 0.6 mm), arranged in six directions, in the direction of wood texture, with angles (0, 45, 90, 135, 180 and 270).) Grade and one layer of poplar wood to (diameter 1.5 mm) with zero degree angle, relative to the length of the plywood. (d)=Document of strong and cross-sectional chemical bonding area between layers of polyvinyl chloride foam sheets, and the formation of a three-dimensional matrix background matrix due to irregularity of holes created between the layers of wood used, in this documentary sample and selected section at this time. Only two matrix connections are shown as cross-sectional intersections. (e)=Polyurethane resin layer to (thickness. 1 mm), to strengthen the physical and mechanical properties of the surface coating of beech board surface, for cosmetic and industrial use. (f)=Wooden nails to (8 mm in diameter), for three-dimensional connection of two-dimensional layers of composite load-bearing fibers, together with the properties of reinforcing the hardness of the composite and preventing the layering of multilayer boards against bending forces.]

FIG. 9: (Documentation of PMP products-3)

[(a)=between compressed layers of polyvinyl chloride foam sheet, diameter (2 and 16 mm). (b)=Processed beech wood board, with primer (Formula. 1), diameter (5 mm). (c)=Processed Russian wood board, with primer (Formula. 1), diameter (4 mm). (d)=Polyurethane resin, thickness (mm), as a coating of Russian wood boards. (e)=Patented surface of Russian board, processed by primer (Formula. 1), with blue pigment.]

FIG. 10: (Documentation of PMP profile products)

[(a)=UPVC door and window profiles. (b)=Processed walnut board, with primer (Formula. 1), cross section (84.4 mm), on profile surface and (13.4 mm), in side strips, as a cover and side and side view Profile. (c)=Processed ash wood board, to cross section (40×4 mm), as the surface and surface view of the back of the UPVC profile.]

FIG. 11: (Documented Thin Seam Wood Laminate)

[(a)=Polyvinyl chloride foam sheet, diameter (16 mm). (b)=Rush processed thin coating, with primer (Formula. 1), diameter (0.5 mm). (c)=Processed ebony coating, with primer (Formula. 1), diameter (0.5 mm).]

FIG. 12: (Possibility of repairs and recycling)

[(a)=Display of the first step of the operation of repairing the thin coating of oak wood, which sanding operation has caused its perforation, which is impregnated with solvent cyclohexanone to dissolve and soften the substrate adhesive. (b)=The perforated part of the coating, by over-processing operations, by electric sanding and the appearance of a layer of adhesive and foam polyvinyl chloride sheet under the coating layer. (c)=The second step of the operation of repairing the coating and separating the damaged coating, from the foam sheet of polyvinyl chloride foam, after dissolving the adhesive under the layer, by solvent cyclohexanone and separating it from the cut part, by a razor. (d)=Cut border lines with razor. (e)=The third step of the coating repair operation and re-gluing of the processed and seamed coating patch to the border of the cut part, with a razor, again using glue (Formula. 2) and cold press. (f)=Two fully sewn lines of patched and polished veneer and all flattened, with the surface of the previous veneer.]

FIG. 13: (UV-sensitive color products)

[(a)=Documented processed wood streaks, ultraviolet light-sensitive paint, under ordinary light bulbs. (b)=The luminosity of the fine-grained natural wood carvings of the processed wood, with primer (Formula. 1), in addition to the red pigment sensitive to ultraviolet light, (documentary view, under the light of ultraviolet lamp.]

FIG. 14: (Documentary color with electrical conductivity)

[(a)=Documentation of the result of the electrical conductivity test of the surface of the coated polyvinyl chloride foam, polyolefin color conductor ((Formula. 3) in addition to graphite powder). (b)=Polyvinyl chloride foam sheet with a diameter (16 mm). (c)=Graphite color of polyolefin with electrical conductivity, thickness (0.4 mm).]

FIG. 15: (Table. 1)

[The table of thermoplastic polyolefin polymers and their corresponding excellent and chemical solvents, for the manufacture of primers, adhesives, paints and polymer cements used and combined, in the manufacture of products obtained from the technical knowledge of making polymeric plywood.]

### DESCRIPTION OF EMBODIMENTS

(Formula. 1)=primer=14(C6H120)+((C2H3CL) n), (Formula. 2)=Glue=6(C6H120)+((C2H3CL) n), (Formula. 3)=paint=9(C6H120)+((C2H3CL) n).

### EXAMPLES

How to make a PMP board for preparing a special chessboard, with dimensions: (17*255*255 mm), with a documentary image of the manufacturing process, presented in the documentary [FIG. 4]: (a)—How to make a primer: According to (Formula. 1), pour 25 grams of PVC base paint, or solid waste UPVC cut, into a beaker and dissolve in 250 cc solvent cyclohexanone, and after 5 minutes to stirring, For at least one to three days, allow the cloud of PVC molecules to dissolve well into the soft and soluble solvent, which, of course, is the best time for the process, under industrial and commercial conditions, for a week and then, on the beaker container put a label, (Primer). (b)—How to make glue: According to (Formula. 2), 25 grams of PVC base paint, or solid waste UPVC cut, is poured into beaker and dissolved in 100 cc, cyclohexanone solvent, and after 5 minutes to stirring, For at least one to three days, allow the cloud of PVC molecules to dissolve well, softly and completely dissolve in the solvent. However, the best time for this process is one week in industrial and commercial conditions and then, on the beaker container put a label, (Glue). (c)—Method of making paint coating: according to (Formula. 3), 25 g of PVC base paint, or UPVC cutting waste, is poured into beaker and dissolved in 150 cc, cyclohexanone solvent, and after 5 minutes to Stirring, for at least one to three days, allow the cloud of PVC molecules to dissolve well into the soft, soluble solvent, which is, of course, the best time for this process is one week in industrial and commercial conditions and then, on the beaker container put a label, (Color). In this step, you can add the desired pigment to the color and then give it time to dissolve well in the paint, especially UV-sensitive pigments such as the [FIG. 13]. (d)—Layer assembly method and construction of polymer board structure: In this step, we paint and saturate all thin wood veneers, with a brush or roller, with a primer solution and in a few steps, and give the opportunity to primer at any stage. It dries completely, and depending on the ambient temperature, we finally need an hour to a day for the solvent to evaporate well, so that the coatings become, completely wood-plastic, Then cut the checkered pattern of the wood veneers with a razor or laser device, such as [FIG. 4-d, e] and fasten them together with paper glue, which can also be made of paper strips for sealing the wood veneer, then use the resulting checkered surface [FIG. 4-d] for the top layer of the top board, along with the surface of the remaining processed oak veneer, to cover the back layer of the top panel, along with the two surfaces of the PVC sheet (16 mm). We apply the glue, Finally, after placing and gluing three layers on top of each other and drawing a roller on the coatings, to remove excess glue and smooth the glue, between the layers and then the resulting set with the contract of two thin sheets of paper, on The two surfaces of the resulting plywood and place between two equal size MDF plates or press plates and by applying equal pressing pressure, by four carpentry clamps and in the four corners of the press plates, half an hour to it, we allow the glue to penetrate into the primer layers of wood and PVC sheets, and then dry well and after half an hour, we open the clamps and one to two days, depending on the ambient temperature, in the open air, we give the resulting board a chance for the glue to reach the required hardness and standard to reach the cutting stage of the board, and after Covering and sanding and initial polishing of the product surface, we cover the two surfaces of the resulting board with paint of (Formula 3).

### INDUSTRIAL APPLICABILITY

1—Production of polyolefin resin for making waterproofing primer and adhesive for use in wood and plastic composite industries, for production of compact board or plywood, from a combination of wood and plastic, with a process at room temperature and without the need to apply high pressure, [FIG. 7, 8, 9, 10 & 11]. 2—Prefabrication of thin wooden coatings, with better adhesion, on plastic or wooden surfaces, at low pressure and normal temperature [FIG. 7]. 3—Manufacturing of second generation wood-plastic plywood, with a process at normal temperature, with the possibility of combining wood with plastic, as the main components of the composite and also, the combination between thermoplastic, or thermoset, or textured layers (Fabric, metal, glass, polymer, carbon) as sub-layers and reinforcements of both fibers or composite background matrix, for use in construction and decoration industries, including: cabinets, office furniture, flooring, wall hangings, false walls and ceilings, building facades, wooden building ceilings, doors and windows , Canopy wall, ship industry, boat, deck making, health industry, advertising, aircraft, model and drone, prefabricated pool, prefabricated wall, handicrafts, concreting, transportation and other modern and designable uses, by facilities to created, by the technical knowledge of making plywood. 4—Production of a new generation of waterproof paints for wood coating, a partial and dry air, including primer solution and thermoplastic polyolefin paint, with the ability to sand and eat and polish and renewability and color recovery, With the possibility of using UV-sensitive pigments [FIG. 13]. 5—Expansion in the production of primers, adhesives and paints with electrical conductivity [FIG. 14-c], by adding graphite powder to the polyolefin resin polyvinyl chloride solution in cyclohexanone or chloroform, in which the adhesive or paint layers also have electrical conductivity applied in the manufacture of electrical functional board boards, with the following uses: anti-electrostatic surface, electronic and circuit applications and the possibility of plating wood and plastic surfaces. 6—Making light wood-plastic sheets, with impregnated and impermeable wood, water-repellent, washable and disinfectant, anti-penetration of acid and alcoholic solutions, with the ability to withstand water vapor and indirect surface temperature, between (60 to 100) degrees Celsius and False walls and ceilings and hospital furniture and equipment and laboratory units, instead of using MDF or steel sheets [FIG. 4, 6, 7, 8 & 9]. 7—Replacing the aluminum sheet used in composite building facades, with thin sheet or processed wood board and waterproof for outdoor use, as well as covering UPVC profiles for making double-glazed doors and windows with natural wood, which is now any two products are in dire need of a commercial market [FIG. 10].

### CITATION LIST

[1]=“Plywood”. Gale's How Products are made. The Gale Group Inc. Retrieved 26 Nov. 2013.

[2]=“Nobel Plywood”. Retrieved 2018-04-

[symbol]

1. A process of making polymeric matrix plywood composite, comprising: a load-Bearing components in composites such as boards or thin wood veneers, characterized in that, the load-Bearing components do not contain any restrictions on the thickens, and can be three-dimensional; a composite background matrix includes primer, adhesive and a paint solution of polyolefin resin type, characterized in that, the composite background matrix is three-dimensional; a Polyolefin interlayer sheets or films To reinforce the composite background matrix, characterized in that, the polyolefin interlayer sheets or films do not contain any restrictions on the thickens; an interlayers combination of load-Bearing fibers to strengthen the composite load-bearing network, characterized in that, the interlayer combination do not contain any restrictions on the thickens; and apply pressure by plywood press machine, characterized in that, the pressure required is lower than the pressure required to make a traditional plywood.

2. A process of making polymeric matrix plywood composite according to claim 1, characterized in that, the load-bearing components such as wood fibers can be reinforced or replaced by the following materials, such as thermoset polymers, thermoplastic polymers, fabric fibers, sheets or mesh metal, carbon fiber, glass fiber, plywood, or any hard material and sheet that the primer and adhesive can penetrate or pass through it.

3. A process of making polymeric matrix plywood composite according to claim 1, characterized in that, the composite background contains one or more types of granules or waste polyolefin materials, such as polyvinyl chloride (PVC), Polyamide (PA), Polyether ether ketone (PEEK), Polyethylene (PE, LDPE, LLDPE, HDPE), Poly(ethylene terephthalate) (PET), Poly(ethylene-vinyl acetate) (EVA), poly(ethylene-vinyl alcohol) (EVOH), polypropylene (PP), Homopolymer (HPPP), Copolymer (CPPP), Polylactic acid (PLA), Polymethyl methacrylate (PMMA), Polyvinyl acetate (PVA), Polytetrafluoroethylene (PTFE), Polyvinyl alcohol (PVAL), Polyvinyl chloride (PVC), Polyvinylidene chloride (PVDC), Cellulose acetate (CA), Polyoxymethylene (POM), Polystyrene (PS), General polystyrene (GPPS), Polystyrene with impact High (HIPS), Polybutylene (PB), Polybutylene terefetalat (PBT), Polycarbonate (PC), or Acrylonitrile butadiene styrene (ABS); One or more types of excellent polymeric solvents such as, Cyclohexanone, Formic acid, Dimethylformamide, Benzene, Toluene, Xylene, Trichloroethane, Acetone, Nitro benzene, Dimethyl sulfoxide, Phenol, Cyclohexane, Trichlorobenzene, Tetralin, Decalin, Deca hydro naphthalene, Fluorine, Tetra hydro naphthalene ,Aliphatic chlorine and thermogen, Fluorine, Hexa Fluorine, tetrahydrofuran, chloroform, sulfoxide, dialexyl amide, lactam alkyl, Tetramethylene sulfoxide, tri methylene sulfide, Trimethylen sulfide, methylene chloride, gasoline, tetrachlorochlorocarbon, Trichloroethylene, 1,2,4-Dichlorobenzene, Methyl ethyl ketone, Ethyl acetate, Amino acetate, 1,4-Dioxane, Pyridine, Curzol, Dichloro chloride Methylene, Dichloromethane, Cyclopentanone, Propylene Carbonate, 1,1,1,3,3,3-Hexafluoro-2-propanol-O-Chlorophenol, Base 2—Hydroxyethylene terephthalate, Butylatedhydroxyl toluene, Ketones, esters, chlorocarbon, aromatic hydrocarbons, Freon, alcohols, Ionic liquids, Ether, Glycol esters, or glycol ethers; one or more types of chemicals, minerals or excellent fillers such as Zinc stearate, cadmium stearate, carbon, graphite, gerafen, titanium oxide, calcium carbonate, sodium carbonate, ceramic, glass, mica, felt, fabric, conductive materials, semiconductor materials, insulation materials or nanotechnology materials.

4. A process of making polymeric matrix plywood composite according to claim 1, characterized in that, the polyolefin interlayer sheets or films contain one or more types of polyolefin materials, such as polyvinyl chloride (PVC), Polyamide (PA), Polyether ether ketone (PEEK), Polyethylene (PE, LDPE, LLDPE, HDPE), Poly(ethylene terephthalate) (PET), Poly(ethylene-vinyl acetate) (EVA), poly(ethylene-vinyl alcohol) (EVOH), polypropylene (PP), Homopolymer (HPPP), Copolymer (CPPP), Polylactic acid (PLA), Polymethyl methacrylate (PMMA), Polyvinyl acetate (PVA), Polytetrafluoroethylene (PTFE), Polyvinyl alcohol (PVAL), Polyvinyl chloride (PVC), Polyvinylidene chloride (PVDC), Cellulose acetate (CA), Polyoxymethylene (POM), Polystyrene (PS), General polystyrene (GPPS), Polystyrene with impact High (HIPS), Polybutylene (PB), Polybutylene terefetalat (PBT), Polycarbonate (PC), or Acrylonitrile butadiene styrene (ABS).

5. A process of making polymeric matrix plywood composite according to claim 3, characterized in that, the composite background matrix consists of a polyolefin resin paint solution that can be combined with organic oils such as flaxseed oil, Canola oil, soya oil or Sunflower oil to making a polyolefin varnishes for use on wood or plastic surface.

6. A process of making polymeric matrix plywood composite according to claim 1, characterized in that, the load-bearing components can be three-dimensional If the process is done with the following components: make regular holes perpendicular to the surface of the polymeric matrix plywood; and then hammer plastic or wooden nails whit the same size as the holes to said, made in the holes with hit.

7. A process of making polymeric matrix plywood composite according to claim 1, characterized in that, the composite background matrix is three-dimensional if the process is done with the following components: make pre-punched holes in the surface of the composite load-bearing fiber layers such as the wood veneers; place the pre-perforated fibers one by one between the reinforcing layers of the composite matrix background; apply the polyolefin adhesive on the surface of the composite layers; apply pressure by plywood press machine; and The three-dimensional and irregular passage of the composite matrix including the primer and polyolefin adhesive through the veins and pores of the wood fibers, so the two layers of the polyolefin reinforcing matrix located on the two back surfaces and on the wood fibers, are connected by the pressure.

8. A process of making polymeric matrix plywood composite according to claim 1, characterized in that, the required pressure is applied at normal temperature.

9. A primer, adhesive or polyolefin paint solution that conducts electricity, include at least: 1 volumetric components of polyolefin granules, such as polyvinyl chloride; 3-7 volumetric components of graphite powder; 7-11 volumetric component of polymeric solvents such as cyclohexanone.

10. A wooden compact board polyolefin composite, comprising: chips or wooden flour, characterized in that, chips or wooden flour are saturated with polyolefin materials; the polyolefin adhesive as a composite background matrix; apply pressure at normal temperature; and in another way apply pressure at a temperature higher than the melting temperature of the polyolefin material used in the composite.

11. A wooden compact board polyolefin composite according to claim 10, characterized in that, the chips or wooden flour are saturated with the polyolefin materials, in a process comprising: chips or dry wooden flour; the Polyolefin primer solution; saturation of the mentioned fibers in the solution of the mentioned polyolefin primer; remove of the fibers from the polyolefin primer solution and dry it; and re-grind the product.

12. A process of making polymeric matrix plywood composite according to claim 4, characterized in that, the polyolefin interlayer sheets or films contain one or more types of polyolefin materials therefore polyolefin profiles for doors, windows, wood-plastic and functional structures, can also be coated with wood fibers or HPL laminate by primers and polyolefin adhesives.
